(19) United States
(12) Patent Application Publication
(10) Pub. No.: US 2022/0245532 A1
(43) Pub. Date: Aug. 4, 2022

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Xiongfan JIN, Kanagawa (JP); Tetsuya KOBAYASHI, Kanagawa (JP); Kengo TOKUCHI, Kanagawa (JP)

(73) Assignee: FUJIFILM Business Innovation Corp., Tokyo (JP)

(21) Appl. No.: 17/389,379

(22) Filed: Jul. 30, 2021

(30) Foreign Application Priority Data
Feb. 4, 2021 (JP) 2021-016189

(51) Int. Cl. G06Q 10/02; G01C 21/34

(52) U.S. Cl. CPC G06Q 10/025; G01C 21/3453; G01C 21/3438

(57) ABSTRACT

An information processing system includes a processor configured to acquire information regarding a purpose of use in a case where a user uses a moving object, the information being information regarding a purpose of use that is capable of being achieved even though the moving object is not moved.

### CROSS-REFERENCE TO RELATED APPLICATIONS

This application is based on and claims priority under 35 USC 119 from Japanese Patent Application No. 2021-016189 filed Feb. 4, 2021.

### BACKGROUND

### (i) Technical Field

The present invention relates to an information processing system, a non-transitory computer readable medium storing a program, and an information processing method.

### (ii) Related Art

JP2020-77287A discloses a method in which one or more owner request places from among candidate places are acquired from an owner and are reported to a driver, and a driver request place from among the owner request places is acquired from the driver and is reported to the owner.

JP2009-48357A discloses a process in which the current share points of a user whose use reservation request has been received by a request reception part is specified from a customer information storage part, and a use reservation for a shared car is preferentially permitted as the specified share points become higher.

JP2012-215921A discloses a system that includes a CS installation information DB including position information of installation places of a plurality of CS, and a CS usage status DB in which the entering time and leaving time of share cars which enter and leave each CS are successively recorded, and a usage status of the CS is stored.

### SUMMARY

In a moving object such as a rental car, a user may use this moving object after making an application.

Aspects of non-limiting embodiments of the present disclosure relate to an information processing system and a non-transitory computer readable medium storing a program that can ascertaining a user's purpose of use in a case where the user uses a moving object for a purpose other than movement.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to acquire information regarding a purpose of use in a case where a user uses a moving object, the information being information regarding a purpose of use that is capable of being achieved even though the moving object is not moved.

### BRIEF DESCRIPTION OF THE DRAWINGS

Exemplary embodiment(s) of the present invention will be described in detail based on the following figures, wherein:

FIG. 1 is a diagram schematically showing an overall configuration of an information processing system;

FIG. 2 is a diagram showing a hardware configuration of a space;

FIG. 3 is a diagram showing an example of a hardware configuration of a space management server;

FIG. 4 is a diagram showing an example of a hardware configuration of a user terminal;

FIG. 5 is a flowchart showing a flow of processes executed in a case where a car as an example of a moving object is reserved;

FIG. 6 is a diagram showing screens displayed on the user terminal in a case where a user reserves a car;

FIGS. 7A and 7B are diagrams showing reservation tables to be referred to in a case where the user reserves the car;

FIGS. 8A and 8B are diagrams showing other display examples on the user terminal;

FIGS. 9A and 9B are diagrams showing other display examples on the user terminal;

FIG. 10 is a diagram showing the inside of an example of a selected car;

FIG. 11 is a diagram showing another example of a selected car;

FIGS. 12A and 12B are diagrams showing other display examples on the user terminal; and

FIG. 13 is a diagram showing a display screen displayed on a user terminal of an applicant for use and a display screen displaying a usage status of a preceding user.

### DETAILED DESCRIPTION

Hereinafter, exemplary embodiments of the present invention will be described with reference to the drawings.

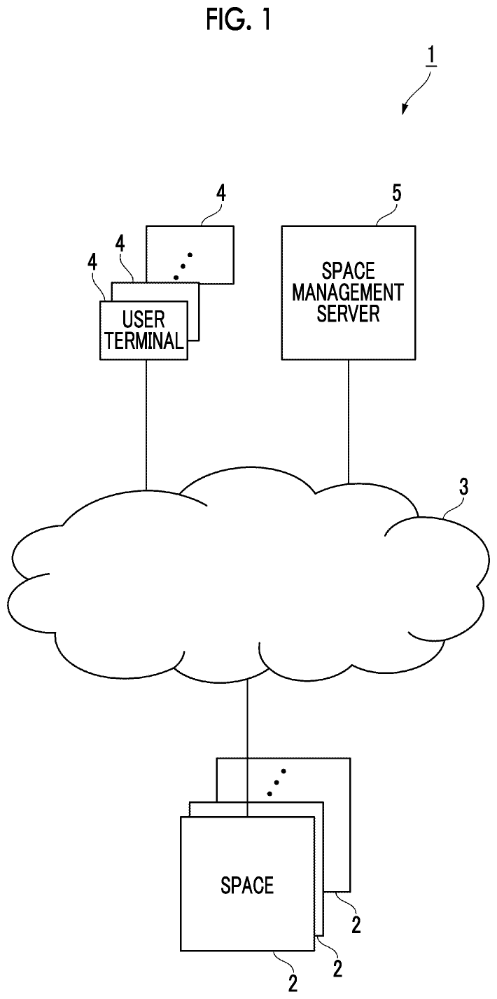

FIG. 1 is a diagram schematically showing an overall configuration of an information processing system according to the present exemplary embodiment.

In the present exemplary embodiment, a plurality of spaces 2 that are examples of places reserved and used by users are provided. Each of the spaces 2 can be reserved, and the user reserves the space 2 in advance and then uses the space 2.

The space 2 as an example of a place includes an internal space of a moving object such as a car, an internal space of a booth, a guest room of an accommodation facility, a conference room of a company, and the like. These are examples of the space 2 separated from the surroundings by a wall, a partition, or the like.

The space 2 in the present exemplary embodiment includes a table, a seat, or the like for which a service is provided at a restaurant, a barber shop, or the like. These are examples of the space 2 open to the surroundings.

The information processing system 1 shown in FIG. 1 is configured with various terminals connected to a cloud network 3.

In FIG. 1, as an example of a terminal connected to the cloud network 3, a user terminal 4 operated by a user and a space management server 5 as an example of an information processing apparatus that manages the space 2 are shown. The space 2 is connected to the cloud network 3. More specifically, various apparatuses are provided in the space 2, and these apparatuses are connected to the cloud network 3.

In the present exemplary embodiment, an electronic lock is attached to a door of the space 2, and each of the spaces 2 can be locked. In the present exemplary embodiment, a person who has the authority to unlock the space 2 can use the space 2.

In a case of unlocking the space 2, the person performing unlocking operates the user terminal 4 thereof to give an instruction for the unlocking. This instruction is sent to the space management server 5, and the space management server 5 receives the instruction. The space management server 5 gives an instruction for unlocking the space 2 that the instruction for unlocking has been given. Consequently, the electronic lock installed in the space 2 is activated, and the space 2 is unlocked.

In the present exemplary embodiment, a portable smartphone is assumed as the user terminal 4. However, the portable user terminal 4 maybe a so-called wearable terminal, a notebook computer, or a game terminal.

The space management server 5 manages various types of information related to the space 2. The space management server 5 manages, for example, information for specifying a user, information for specifying the space 2 that is a reservation target, the start date and time of the reservation, and the end date and time of the reservation.

The information for specifying a user includes, for example, the name, the gender, the age, an account, a user ID, a password of a user, and management information attached to an individual. The information for specifying the space 2 that is a use target includes, for example, information for specifying an address or a location, and a name or a number for management.

The space management server 5 also functions as a control apparatus and controls various apparatuses installed in the space 2.

The control apparatus may be installed in each space 2 so as to correspond to each of the spaces 2. In this case, the control apparatus installed in each space 2 controls various apparatuses installed in each space 2.

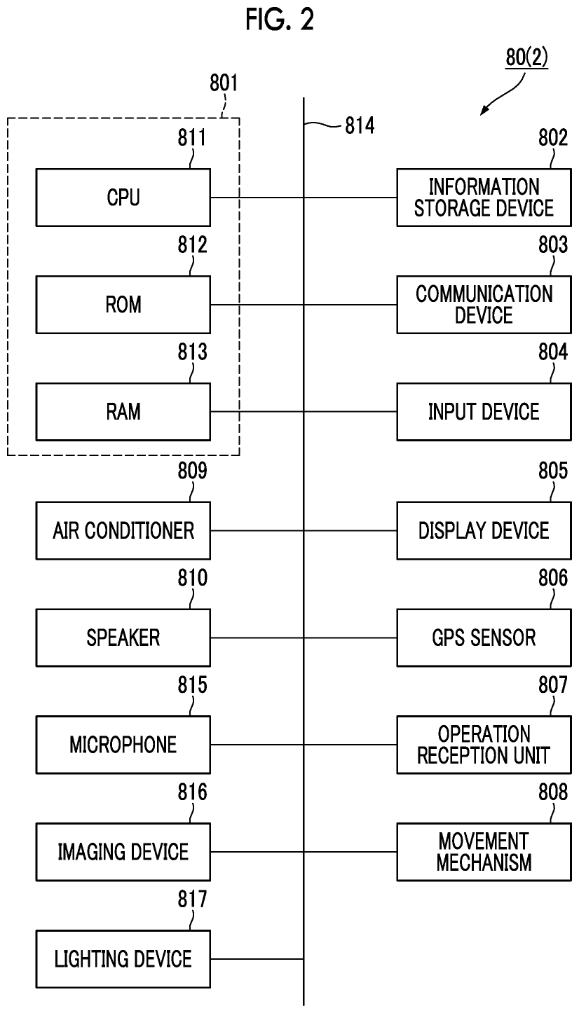

FIG. 2 is a diagram showing a hardware configuration of space 2.

Here, a case where the space 2 is implemented by a car 80 that is an example of a moving object will be illustrated.

FIG. 2 shows an example of the car 80. There are various forms of the car 80, and, depending on the car 80 (that will be described later) that a user intends to use, some of the various functional units shown in FIG. 2 need not be provided, or conversely, other functional units that realize functions other than the functional units shown in FIG. 2 may be provided.

The car 80 that implements the space 2 is provided with an information processing unit 801, an information storage device 802 that stores information, and a communication device 803 that realizes wireless communication. In the present exemplary embodiment, between the car 80 and an external device (not shown) outside the car 80 perform communication via the communication device 803.

The car 80 includes an input device 804 such as a touch sensor, a display device 805 such as a liquid crystal display and an organic electroluminescence (EL) display, and a global positioning system (GPS) sensor 806 that obtains a position of the car 80.

The car 80 is provided with an operation reception unit 807 that receives a user's driving operation, such as a steering wheel, an accelerator, and a brake.

The car 80 is provided with a movement mechanism 808 used to move the car 80, such as an engine and a transmission. The car 80 is provided with an air conditioner 809 used to adjust the temperature inside the car 80.

The inside of the car 80 is provided with a speaker 810 that outputs sound, a microphone 815 that acquires sound inside the car 80, an imaging device 816 that images the inside of the car 80, and a lighting device 817 that brightens the inside of the car 80.

The imaging device 816 is provided with an imaging element such as a CCD or CMOS, and the imaging device 816 uses the imaging element to image the inside of the car 80.

In a case where the car 80 is a large car 80 such as a camper, a facility such as a table may be provided inside the car 80.

The information processing unit 801 has a central processing unit (CPU) 811 as an example of a processor, a read only memory (ROM) 812 in which basic software, a basic input output system (BIOS), and the like are stored, and a random access memory (RAM) 813 that is used as a work area.

The CPU 811 may be multi-cores. The ROM 812 may be a rewritable non-volatile semiconductor memory. The information processing unit 801 is a so-called computer.

The information storage device 802 is configured with, for example, a hard disk drive. In other words, the information storage device 802 is configured with, for example, a device that reads and writes data to and from a non-volatile storage medium in which a magnetic material is coated on a surface of a disk-shaped substrate. However, the information storage device 802 may be a semiconductor memory or a magnetic tape.

These functional units provided in the car 80 are connected via a bus 814 or a signal line (not shown).

Here, a program executed by the CPU 811 may be provided to the car 80 in a state of being stored in a computer-readable recording medium such as a magnetic recording medium (a magnetic tape, a magnetic disk, or the like), an optical recording medium (an optical disk or the like), a magnetooptical recording medium, or a semiconductor memory.

The program executed by the CPU 811 may be provided to the car 80 by using communication means such as the Internet.

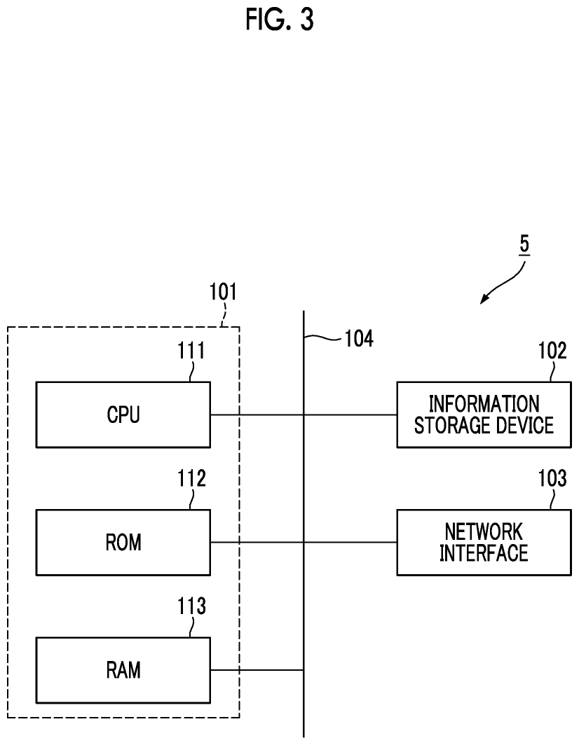

FIG. 3 is a diagram showing an example of a hardware configuration of the space management server 5.

The space management server 5 as an example of an information processing apparatus has an information processing unit 101, an information storage device 102 that stores information such as management data, and a network interface 103 that realizes communication via a local area network (LAN) cable or the like.

The information processing unit 101 has a central processing unit (CPU) 111 as an example of a processor, a read only memory (ROM) 112 in which basic software, a basic input output system (BIOS), and the like are stored, and a random access memory (RAM) 113 that is used as a work area.

The CPU 111 may be multi-cores. The ROM 112 may be a rewritable non-volatile semiconductor memory. The information processing unit 101 is a so-called computer.

The information storage device 102 is configured with, for example, a hard disk drive. In other words, the information storage device 102 is configured with, for example, a device that reads and writes data to and from a non-volatile storage medium in which a magnetic material is coated on a surface of a disk-shaped substrate. However, the information storage device 102 may be a semiconductor memory or a magnetic tape.

The space management server 5 also includes input devices such as a keyboard and a mouse, and a display device such as a liquid crystal display, in a case where necessary.

The information processing unit 101, the information storage device 102, and the network interface 103 are connected to each other via a bus 104 or a signal line (not shown).

Here, a program executed by the CPU 111 may be provided to the space management server 5 in a state of being stored in a computer-readable recording medium such as a magnetic recording medium (a magnetic tape, a magnetic disk, or the like), an optical recording medium (an optical disc or the like), a magnetooptical recording medium, or a semiconductor memory.

The program executed by the CPU 111 may be provided to the space management server 5 by using communication means such as the Internet.

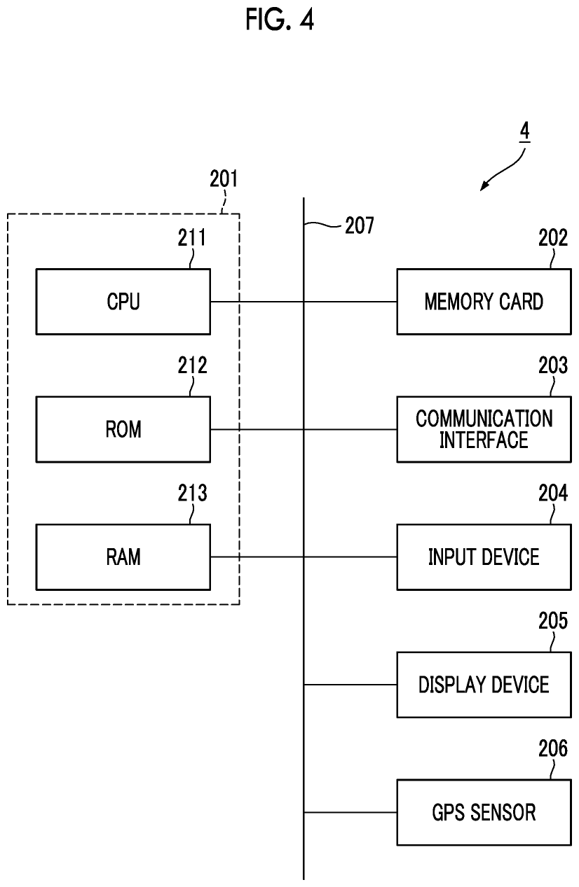

FIG. 4 is a diagram showing an example of a hardware configuration of the user terminal 4. In the configuration shown in FIG. 4, a case where the user terminal 4 is a smartphone is assumed.

The user terminal 4 has a control unit 201 that controls an operation of the entire apparatus, a memory card 202 that stores various data, various communication interfaces 203 that comply with wireless communication standards, an input device 204 such as a touch sensor, a display device 205 such as a liquid crystal display or an organic electroluminescence (EL) display, and a global positioning system (GPS) sensor 206.

The control unit 201 has a CPU 211, a ROM 212 in which firmware, a BIOS, and the like are stored, and a RAM 213 used as a work area. The CPU 211 may be multi-cores. The ROM 212 may be a rewritable non-volatile semiconductor memory.

The communication interface 203 is, for example, an interface used for connection to a mobile communication system or an interface used for connection to a wireless LAN.

The GPS sensor 206 is a sensor that receives radio waves from GPS satellites and measures a position of the user terminal 4. Latitude, longitude, and altitude information output from the GPS sensor 206 provides the current position of the user terminal 4. The GPS sensor 206 may be compatible with an indoor positioning system.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In other words, various processes described below may be performed by using one information processing apparatus provided with a processor, or may be performed by using a plurality of information processing apparatuses each provided with a processor. More specifically, the information processing system 1 of the present exemplary embodiment may be configured such that one information processing apparatus provided with a processor executes processes, and the information processing system 1 of the present exemplary embodiment each may include a plurality of information processing apparatuses, and the processes may be distributed and executed by using the plurality of information processing apparatuses.

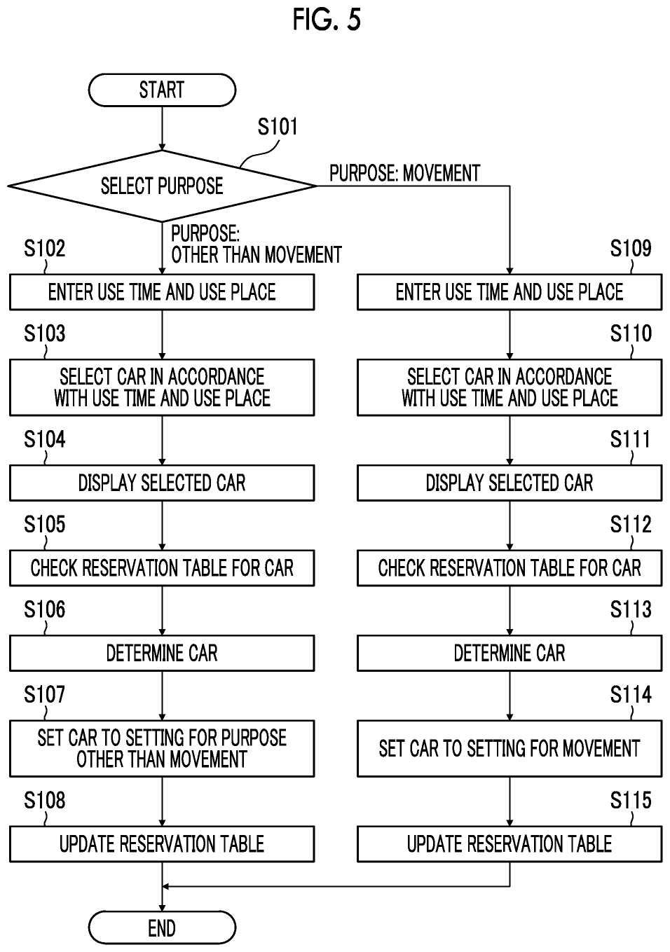

FIG. 5 is a flowchart showing a flow of processes executed in a case where the car 80 as an example of a moving object is reserved. More specifically, FIG. 5 shows a flow of processes executed in a case where the car 80 for car sharing is reserved by a user.

In the present exemplary embodiment, in a case where the user reserves the car 80, first, the user selects whether to use the car 80 for a purpose other than movement or to use the car 80 for the purpose of movement (step S101).

In other words, the user selects whether to use the inside of the car 80 as the space 2 described above or to use the car 80 for movement.

In other words, the user selects whether to use the space inside the car 80 for work or the like or to use the car 80 for movement thereof.

In other words, in step S101, the user selects a purpose of use of the car 80.

Consequently, in the present exemplary embodiment, the CPU 111 (the CPU 111 of the space management server 5) as an example of a processor provided in the space management server 5 acquires information regarding the purpose of use in a case where the user uses the car 80.

More specifically, in the present exemplary embodiment, the user terminal 4 is operated by the user, and information regarding the purpose of use is entered by the user.

The information regarding the purpose of use is transmitted to the space management server 5, and the space management server 5 acquires the information regarding the purpose of use.

In the present exemplary embodiment, in a case where the user uses the car 80 for a purpose other than movement, such as using the car 80 as a workspace, the CPU 111 acquires information regarding the purpose of use in a case where the user uses the car 80, the information being information regarding a purpose of use that can be achieved even though the car 80 is not moved.

The use of the car 80 for a purpose other than movement can be realized even in a state in which the car 80 is not moved and is stopped. In the present exemplary embodiment, the CPU 111 acquires the information regarding a purpose of use that can be achieved even though the car 80 is not moved.

On the other hand, in a case where the user uses the car 80 for the purpose of movement, the CPU 111 acquires information regarding a purpose of use that can be achieved by moving the car 80.

The “moving object” is not limited to the car 80, and corresponds to a “moving object” as long as the moving object can be moved in a state in which the user is riding therein, such as a ship, an aircraft, a helicopter, a train, a motorcycle, or a bicycle.

In the present exemplary embodiment, a case where the car 80 used in car sharing in which the car 80 is shared by a plurality of persons is used as a workspace or the like will be described. However, the present invention is not limited to this, and, for example, the car 80 rented out as a rental car may be used as a workspace or the like.

In addition, for example, the car 80 owned by an individual or a corporation and parked at a parking lot may be rented out for a workspace or the like without being rented out for movement.

It is assumed that the user rents the car 80 for eating, sleeping, or the like, and an application of the car 80 is not limited to the use as a workspace, but the car 80 may be used for eating, sleeping, and the like.

In other words, among purposes of use of the car 80, the purposes of use other than movement include not only work but also eating and sleeping.

In a case where the user selects a purpose other than movement, the user further operates the user terminal 4 to enter a use time and a use place (step S102).

In this case, the CPU 111 performs a search process for the car 80 based on the use time and the use place entered by the user, and selects the car 80 according to the use time and the use place (step S103).

Specifically, the CPU 111 performs a search process for the car 80 based on the use time and the use place entered by the user, and selects the car 80 to be used by the user.

More specifically, in this case, the CPU 111 selects the car 80 that is free in the use time entered by the user and is present within a predefined distance from the use place entered by the user. Select car 80 from among candidates of the plurality of cars 80.

The CPU 111 transmits information regarding the selected car 80 to the user terminal 4. Consequently, the information regarding the selected car 80 is displayed on the user terminal (step S104).

Specifically, the user terminal 4 displays information regarding the car 80 that can be used during the use time entered by the user and is within a predefined distance from the use place entered by the user.

In other words, the user terminal 4 displays the candidates of the cars 80 that can be used by the user.

Thereafter, the user further performs an operation on the user terminal 4 in which the candidates of the cars 80 are displayed such that a reservation table for the cars 80 is displayed on the user terminal 4.

The user checks the displayed reservation table (step S105). Next, the user determines the car 80 to be used (step S106).

Thereafter, the CPU 111 sets the car 80 to a setting for the purpose other than movement with respect to the car 80 determined by the user in step S106 (step S107).

Next, the CPU 111 updates the reservation table for the car 80 reserved by the user to a reservation table in which the reservation of the user is reflected (step S108).

The process in step S107 will be described in detail. In step S107, as described above, the CPU 111 sets the car 80 to a setting for the purpose other than movement with respect to the car 80 determined by the user in step S106.

In other words, in this case, the CPU 111 sets the car 80 to a setting correlated with the above-described purpose of use that can be achieved even though the car 80 is not moved.

In this case, in the car 80, in a case where the user uses the car 80, a setting based on details of this setting is set. More specifically, in this case, immediately before the reservation start time or the like, the CPU 811 (refer to FIG. 2) provided in the car 80 performs processes in accordance with the above-described setting set by the CPU 111.

In the present exemplary embodiment, as described above, the CPU 111 acquires the information regarding the purpose of use that can be achieved even though the car 80 is not moved. In this case, the CPU 111 sets the car 80 to a setting correlated with the purpose of use that can be achieved even though the car 80 is not moved.

In other words, in the present exemplary embodiment, in this case, the CPU 111 sets the car 80 to a setting different from a setting correlated with a purpose of use that can be achieved by moving the car 80.

In the present exemplary embodiment, the setting correlated with the purpose of use that can be achieved even though the car 80 is not moved is different from the setting correlated with the purpose of use that can be achieved by moving the car 80.

Therefore, in a case where the user selects a purpose of use that can be achieved even though the car 80 is not moved and acquires information regarding the purpose of use, the CPU 111 sets the car 80 to a setting different from a setting correlated with a purpose of use that can be achieved by moving the car 80.

Specifically, in this case, the CPU 111 sets, for example, the car 80 to a setting that the user cannot perform a driving operation.

In other words, in this case, the CPU 111 sets the car 80 to a setting to restrict functions for driving. In other words, in this case, the CPU 111 sets the car 80 to a setting that the user cannot move the car 80.

More specifically, the CPU 111 sets, for example, the car 80 to a setting that the operation reception unit 807 is not moved and thus the user cannot move the car 80.

For example, the CPU 111 sets the car 80 to a setting that a control signal for operating the movement mechanism 808 is not transmitted to the movement mechanism 808 for moving the car 80 (refer to FIG. 2) and thus the user cannot move the car 80.

In a case where the car 80 is a car 80 that is moved through automated driving, the CPU 111 sets the car 80 to a setting that a control signal for prohibiting automated driving is transmitted to the car 80 and thus the car 80 is not moved.

On the other hand, even in a case where the user selects a purpose of use that can be achieved even though the car 80 is not moved, the CPU 111 sets a setting that the display device 805 (refer to FIG. 2) such as a display installed in the car 80, the air conditioner 809 adjusting the temperature inside the car 80, the lighting device 817, and the like can be used by the user. In this case, functions of the car 80 according to the purpose other than the movement, which is the purpose of use of the car 80 to be used by the user, are realized.

In a case where the user selects a purpose of use that can be achieved even though the car 80 is not moved, as described above, the CPU 111 sets the car 80 to a setting that the number of portions of the car 80 that can be operated by the user is smaller than in a setting correlated with a purpose of use that can be achieved by moving the car 80.

In other words, in the setting correlated with the purpose of use that can be achieved even though the car 80 is not moved, functions that can be used by the user are restricted, and thus the user cannot perform a driving operation on the car 80.

On the other hand, in the present exemplary embodiment, such a restriction is not made in the setting correlated with the purpose of use that can be achieved by moving the car 80, and the user can use all the functions of the car 80.

In the present exemplary embodiment, in a case where the reservation time for the car 80 comes, the user comes to the car 80 and uses the car 80.

Specifically, in a case where the user reserves the car 80 for a purpose other than movement, the user performs work such as office work or a meeting via the WEB, or eating or sleeping inside the stopped car 80.

As described above, in a case where the car 80 is used for a purpose other than movement, a larger place for a workspace or the like is secured compared with a case where the car 80 is not used for a purpose other than movement.

Examples of the place for a workspace include a rental conference room or a space provided in one room of a building, but in a case where a moving object such as the car 80 is also used as a workspace or the like, a larger space for a workspace or the like is secured.

In a case where the car 80 is used as a workspace or the like as in the present exemplary embodiment, the car 80 will be used for purposes other than car sharing and car renting. In this case, a rent-a-car side that lends the car 80 also has a merit in that an operating rate of the car 80 to be rented increases.

On the other hand, in a case where the purpose selected by the user in step S101 is “movement”, the processes in and after step S109 are executed.

In the process in step S109, in the same manner as in the above step S102, the user operates the user terminal 4 to enter a use time and a use place.

In this case, the CPU 111 performs a search process for the car 80 and selects the car 80 in accordance with the use time and the use place (step S110).

More specifically, also in this case, the CPU 111 selects the car 80 that is free in the use time entered by the user and is present within a predefined distance from the use place entered by the user.

The CPU 111 transmits information regarding the selected car 80 to the user terminal 4. Consequently, the information regarding the selected car 80 is displayed on the user terminal 4 in the same manner as described above (step S111).

Thereafter, the user performs an operation on the user terminal 4 to display the reservation table for the car 80 displayed on the user terminal 4, and checks the reservation table (step S112). Next, the user determines the car 80 to be used (step S113).

Thereafter, the CPU 111 sets the car 80 to a setting for movement with respect to the car 80 determined by the user in step S113 (step S114).

In this case, in the car 80, in a case where the user uses the car 80, a setting based on details of this setting is performed. More specifically, in this case, immediately before the reservation start time or the like, the CPU 811 (refer to FIG. 2) provided in the car 80 performs processes in accordance with the above-described setting set by the CPU 111.

After the process in step S114, the CPU 111 updates the reservation table for the car 80 reserved by the user to a reservation table in which the reservation of the user is reflected (step S115).

In step S114, the CPU 111 sets the car 80 to a setting for movement with respect to the car 80 determined by the user in step S113.

Specifically, in this case, the CPU 111 sets of the car 80 to a setting correlated with the purpose of use that can be achieved by moving the car 80.

More specifically, in this case, the CPU 111 sets the car 80 a setting that the user can perform operations necessary for driving the car 80, such as a steering wheel operation. More specifically, in this case, the CPU 111 sets a setting that the operation reception unit 807 is moved and thus the movement mechanism 808 is moved. In this case, the functions of the car 80 in accordance with a purpose of movement that is the purpose of use of the car 80 that the user intends to use are realized.

In this case, the CPU 111 sets a setting that the display device 805 such as a display installed in the car, the air conditioner 809 adjusting the temperature inside the car, the lighting device 817, and the like can be used by the user.

In other words, in this case, the CPU 111 sets a setting that all the functions of the car 80 can be used.

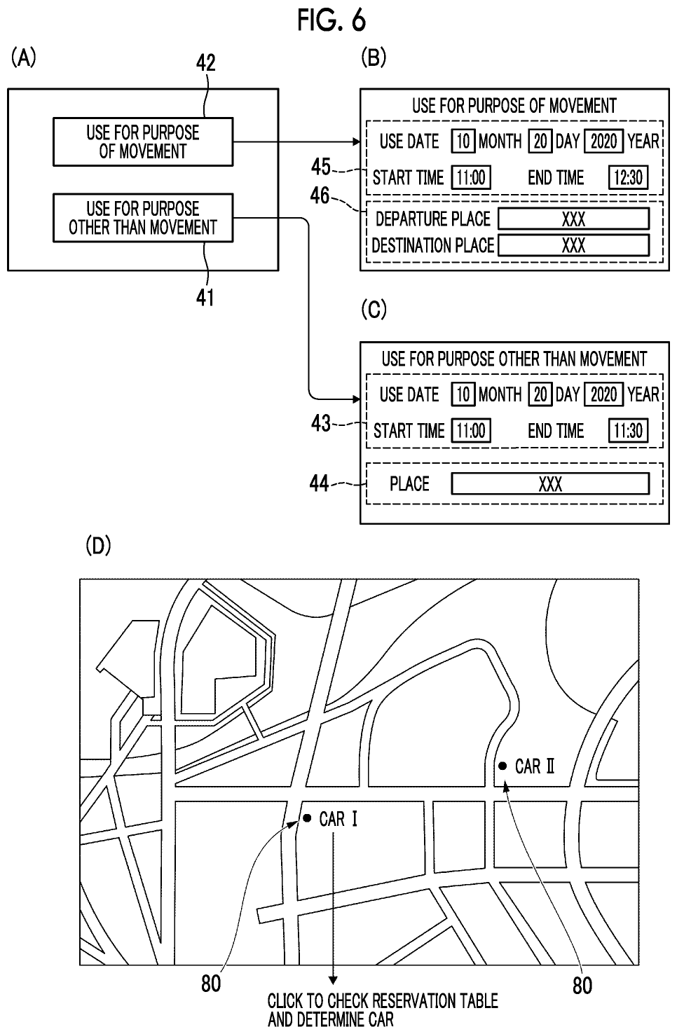

FIG. 6 is a diagram showing screens displayed on the user terminal 4 in a case where the user reserves the car 80.

In the present exemplary embodiment, as described above, in a case where the user reserves the car 80, the user selects a purpose of use of the car 80. In other words, the user selects whether to use the car 80 for a purpose other than movement or to use the car 80 for the purpose of movement.

In the present exemplary embodiment, in a case where this selection is performed, the user terminal 4 displays the screen shown a part (A) in FIG. 6.

A selection item (hereinafter, referred to as a “non-movement selection item 41”) selected in a case where the user uses the car 80 for a purpose other than movement is displayed on the screen shown the part (A) in FIG. 6.

A selection item (hereinafter, referred to as a “movement selection item 42”) selected in a case where the user uses the car 80 for the purpose of movement is displayed on the screen shown the part (A) in FIG. 6.

In the present exemplary embodiment, in a case where the user selects, for example, the non-movement selection item 41, the screen shown a part (C) in FIG. 6 is displayed.

A display 43 for entering a desired date and time and a display 44 for entering a desired place are performed on the screen shown the part (C) in FIG. 6. In the present exemplary embodiment, the user performs an operation on this screen and enters a desired date and time and a desired place.

On the other hand, in a case where the user selects the movement selection item 42, the screen shown apart (B) in FIG. 6 is displayed.

A display 45 for entering a desired date and time and a display 46 for entering a desired place are also performed on the screen as described above. The user performs an operation on the screen and enters a desired date and time and a desired place.

In a case where the user uses the car 80 for the purpose of movement (in a case where the user selects the movement selection item 42), as shown the part (B) in FIG. 6, fields for entering a departure place and a destination place are displayed in a display 46 for entering a desired place. In a case of using the car 80 for movement, the user enters information regarding a departure place and a destination place.

It is not necessary to enter the information regarding the destination place, and a case where the information regarding the destination place is not entered is supposed.

Specifically, a usage aspect in which the car 80 is returned to the departure place is assumed, and, in this case, the information regarding the destination place is unnecessary, and the information regarding the destination place may not be entered.

A part (D) in FIG. 6 is a diagram showing a screen that is displayed on the user terminal 4 and on which the car 80 selected by the CPU 111 is displayed. In other words, the part (D) in FIG. 6 is a diagram showing a screen displayed on the user terminal 4 in the processes in steps S104 and 5111 described above.

In the present exemplary embodiment, as described above, the user terminal 4 displays information regarding the car 80 that is selected by the CPU 111 and matches the user's use conditions (a use time and a use place).

The user operates the user terminal 4 on which the screen shown the part (D) in FIG. 6 is displayed, selects the car 80 to be used, and determines the car 80 to be used.

More specifically, in determining the car 80, first, the user selects each of the displayed plurality of cars 80 and displays a reservation table corresponding to each car 80. The user refers to each of the reservation tables and determines the car 80 to be used.

More specifically, in this example, a car I and a car II are displayed as the cars 80, and the user selects each of the displayed cars I and II to display a reservation table corresponding to each car 80.

The user refers to each of the reservation tables to determine the car 80 to be used.

Thereafter, in the present exemplary embodiment, as described above, with respect to the car 80 determined by the user, the CPU 111 sets the car 80 to either a setting corresponding to a purpose other than movement or a setting corresponding to the purpose of movement.

In a case where the car 80 determined by the user is set to a setting corresponding to the purpose other than movement, the CPU 111 sets the car 80 to the setting that the user cannot drive the car 80 as described above.

On the other hand, in a case where the car 80 determined by the user is set to a setting corresponding to the purpose of movement, the CPU 111 sets the car 80 to a setting that the user can drive the car 80.

Thereafter, in the present exemplary embodiment, as described above, the CPU 111 updates the reservation table of the car 80 determined and reserved by the user to the reservation table reflecting the reservation of the user.

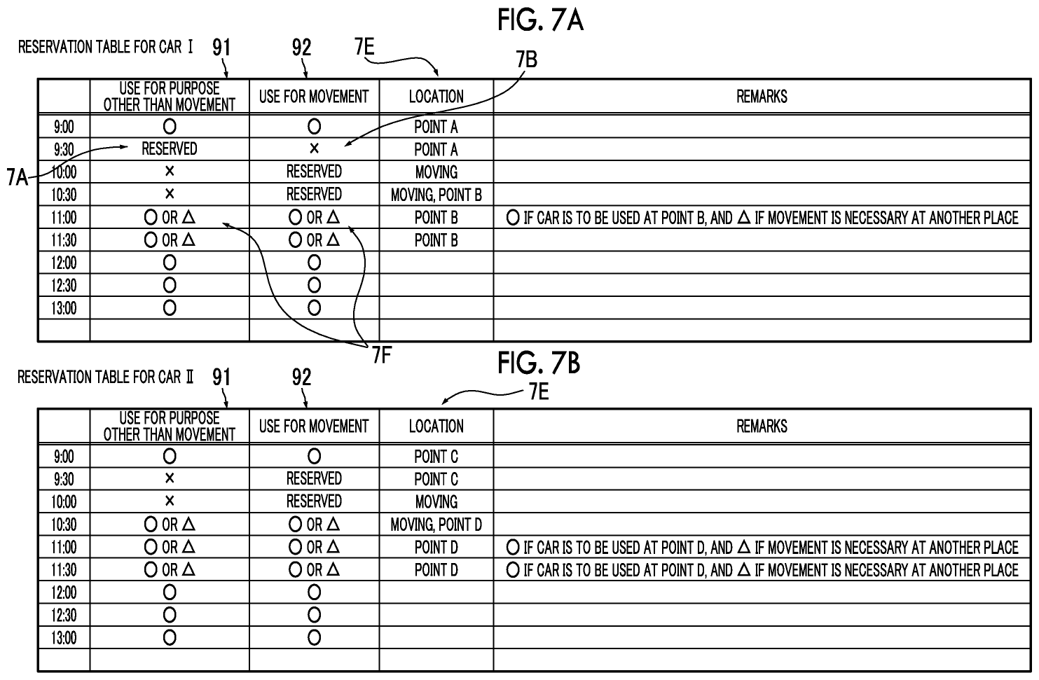

FIGS. 7A and 7B are diagrams showing reservation tables to be referred to in a case where the user reserves the car 80.

The reservation table shown in FIG. 7A shows the reservation table corresponding to the car I the part (D) in FIG. 6, and the reservation table shown in FIG. 7B shows the reservation table corresponding to the car II the part (D) in FIG. 6.

In the reservation tables shown in FIGS. 7A and 7B, a reservation field 91 corresponding to a purpose other than movement and a reservation field 92 corresponding to a purpose of movement are provided.

In these reservation tables, a portion marked with “o” indicates that no reservation has been made yet and that a reservation is possible.

In a case where the reservation is confirmed for the purpose other than the movement or the purpose of the movement in these reservation tables, information “reserved” is registered as indicated by the reference sign 7A.

With respect to use for other purposes, information (indicated as “x” in the figure) indicating that the reservation cannot be made is registered as indicated by the reference sign 7B.

Both “reserved” and “x” indicate that reservations cannot be accepted any more.

In these reservation tables, as indicated by the reference sign 7E, information regarding a location of the car 80 is registered for each reservation time period. In a case where the car 80 is used for the purpose of movement, a location of the car 80 is changed.

in these reservation tables, as indicated by the reference sign 7F, information “0 or Δ” is registered in the reservation field 91 corresponding to a purpose other than the movement and the reservation field 92 corresponding to the purpose of the movement.

The information “o or Δ” indicates that the car 80 has been moved from an original place to another place, and thus the user at this original place has to move to the other place in order to use the car 80. The information “o or Δ” indicates that the user at the original place cannot use the car 80 unless the car 80 is moved to the original place through automated driving.

The information “o or Δ” indicates that the user at the other place can use the car 80.

Specifically, for example, the reservation table in FIG. 7A exemplifies a case where the car 80 is initially located at a point A that is the original place, and is then moved to a point B that is the other place.

In the reservation table of FIG. 7A, for example, in a time period of “11:00 to 11:30”, the information “o or Δ” is registered in the reservation field 91 corresponding to the purpose other than the movement and the reservation field 92 corresponding to the purpose of the movement.

The display of “o or Δ” indicates that the user at the point B can use the car 80.

This display of “o or Δ” indicates that the user at point A cannot use the car 80 unless the user at the point A moves to the point B, or the car 80 at point B is moved to point A through automated driving.

In a case where the user selects the car I shown the part (D) in FIG. 6, the user refers to the reservation table shown in FIG. 7A.

In the reservation table shown in FIG. 7A, the car 80 is free in each time period of “09:00 to 09:30”, “11:00 to 11:30”, “11:30 to 12:00”, “12:00 to 12:30”, “12:30 to 13:00” and “13:00 to 13:30”.

The user can reserve the car 80 for purposes other than movement in these time periods. The user can reserve the car 80 for the purpose of movement in these time periods.

FIG. 7B is a diagram showing a reservation table for the car II the part (D) in FIG. 6.

In this reservation table, the car 80 is present at a point C in the time period of “09:00 to 09:30”.

In this example, the car 80 is moved in the time periods of “09:30 to 10:00”, “10:00 to 10:30”, and “10:30 to 11:00”, and the car 80 is moved from the point C to a point D in these time periods.

In this example, the car 80 is present at the point D in the time periods of “11:00 to 11:30” and “11:30 to 12:00”.

In this example, the car 80 is free in each time period of “09:00 to 09:30”, “10:30 to 11:00”, “11:00 to 11:30”, “11:30 to 12:00”, “12:00 to 12:30”, “12:30 to 13:00”, and “13:00 to 13:30”.

The user can reserve the car 80 for purposes other than movement in these time periods. The user can also reserve the car 80 for the purpose of movement in these time periods.

In the reservation table shown in FIG. 7B, the car 80 is initially located at the point C, and then the car 80 is moved to the point D that is another place.

In this reservation table, for example, in the time period of “11:00 to 11:30”, the information “o or Δ” is registered in the reservation field 91 corresponding to the purpose other than the movement and the reservation field 92 corresponding to the purpose of the movement.

The display of “o or Δ” indicates that the user at the point D can use the car 80.

This display of “o or Δ” indicates that the user at point C cannot use the car 80 unless the user at the point C moves to the point D, or the car 80 at point D is moved to point C through automated driving.

In a case where the user selects the car II the part (D) in FIG. 6, the user refers to the reservation table shown in FIG. 7B.

Other Display Examples

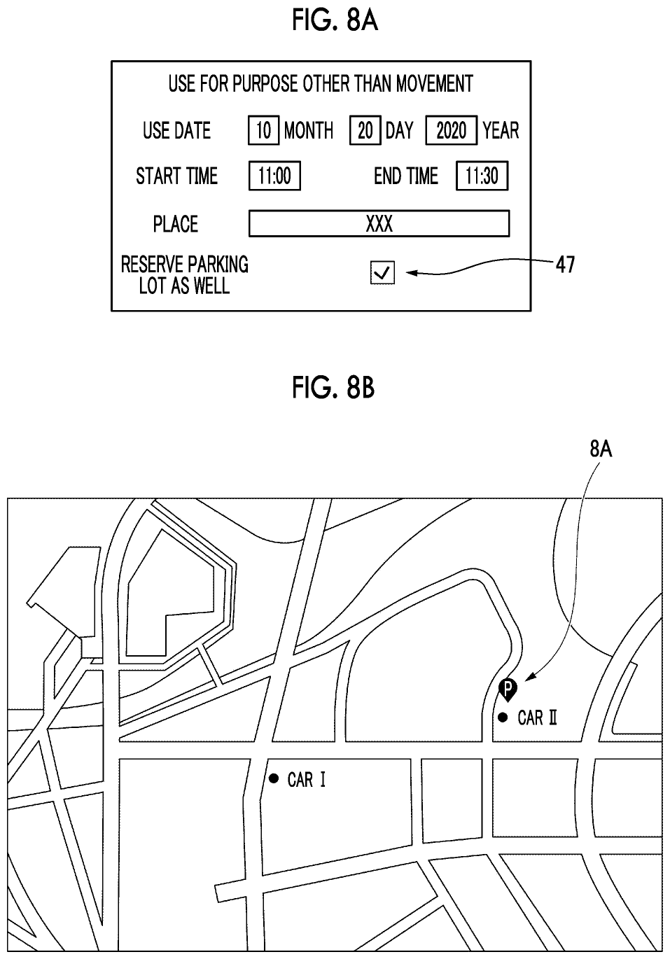

FIGS. 8A and 8B are diagrams showing other display examples on the user terminal 4.

In the display example shown in FIG. 8A, not only the car 80 but also a selection item (hereinafter, a “parking lot selection item 47”) for whether or not to reserve a parking lot for parking the car 80 is displayed.

The display screen shown in FIG. 8A is a display screen in a case where the user reserves the car 80 for a purpose other than movement, and the parking lot selection item 47 is also displayed on the display screen.

The parking lot selection item 47 is a selection item for allowing the user to select whether or not to reserve a parking lot for parking the car 80.

In this example, in a case where the user reserves the car 80 in a state in which the parking lot selection item 47 is selected, not only the car 80 but also a parking lot for parking the car 80 is reserved.

Specifically, in the present exemplary embodiment, for example, a parking lot indicated by the reference sign 8A in FIG. 8B is also reserved.

More specifically, this example exemplifies a case where the car II in FIG. 8B is selected by the user and the parking lot selection item 47 is selected by the user, and, in this case, not only the car II but also a parking lot for parking this car II is reserved.

More specifically, in this case, the parking lot is also reserved during a period from the start to the end of the reservation time for the car 80.

In this process example, in a case where the CPU 111 acquires information regarding a purpose of use that can be achieved even though the car 80 is not moved, the CPU 111 performs a process of securing a place for parking the car 80.

Specifically, in a case where the CPU 111 acquires the information regarding the purpose of use that can be achieved even though the car 80 is not moved, and the user gives a permission such as selecting the parking lot selection item 47, the CPU 111 performs the process of securing a place for parking the car 80.

In other words, in a case where the CPU 111 acquires the information regarding the purpose of use that can be achieved even though the car 80 is not moved, and there is an instruction from the user, the CPU 111 performs the process of securing a place for parking the car 80.

Regarding a reservation for a place for parking the car 80, in a case where the user starts to use the car 80, a parking lot where the car 80 is parked may be continuously reserved, or a place different from this parking lot may be reserved.

In a case where the user starts to use the car 80 and continuously reserves the parking lot where the car 80 is parked, the user can use the car 80 without moving the car 80.

Other Display Examples

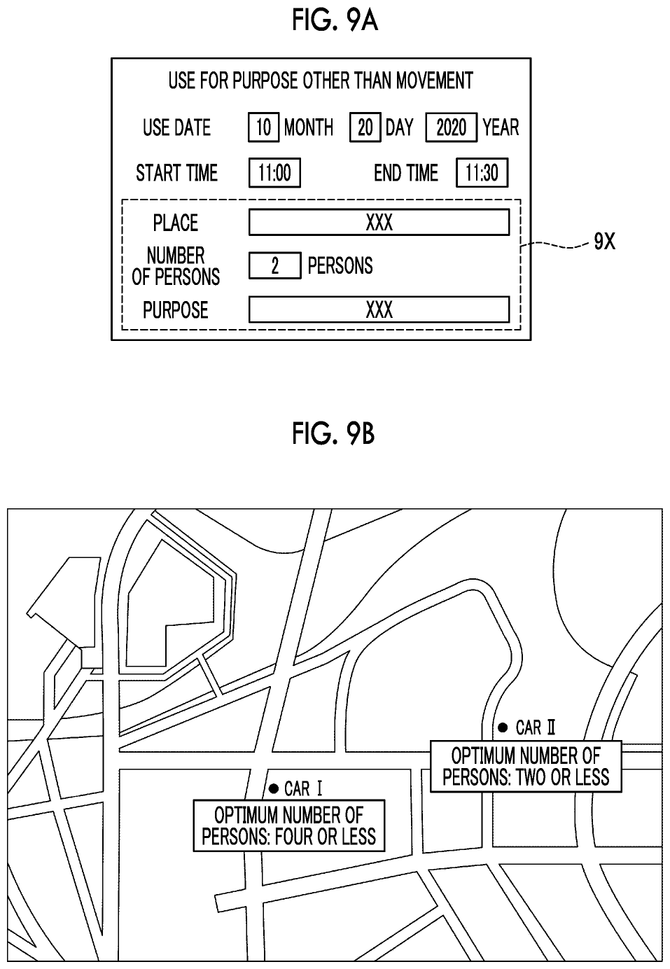

FIGS. 9A and 9B are diagrams showing other display examples on the user terminal 4.

In the display examples shown in FIGS. 9A and 9B, an entry field 9X for entering not only the date and time of use but also a use place, the number of persons using the car 80 and a purpose of use of the car 80 is provided.

In other words, in this example, the entry field for entering the number of persons using the car 80 and a purpose of using the car 80 is also displayed on a display screen in a case where the car 80 is reserved for a purpose other than movement.

In other words, in this example, an information entry field for obtaining more detailed information regarding a purpose of use is displayed in a state in which information regarding a purpose of use such as a purpose other than movement has already been obtained.

In a case where the user enters information to the display screen shown in FIG. 9A, the CPU 111 selects the car 80 to be used for a purpose other than movement based on the entered information as described above.

In this example, information such as two persons is entered as information regarding the number of persons using the car 80, and the CPU 111 selects the car 80 that can be used by two or more users.

In other words, in this case, the CPU 111 selects the car 80 to be used by the user based on the number of users using the car 80.

In this case, as shown in FIG. 9B, the user terminal 4 displays information regarding the number of persons using the car 80 for each of the cars 80 selected by the CPU 111.

More specifically, in this example, information such as an “optimum number of persons: four or less” and an “optimum number of persons: two or less” is displayed as the information regarding the number of persons using the car 80.

In this case, the CPU 111 selects the car 80 in consideration of the date and time of use, the use place of use, the number of users, and the above-described detailed purpose of use.

Here, examples of the detailed purpose of use include eating, sleeping, office work, a WEB meeting, and a meeting-type conference.

The CPU 111 selects the car 80 in consideration of these purposes of use.

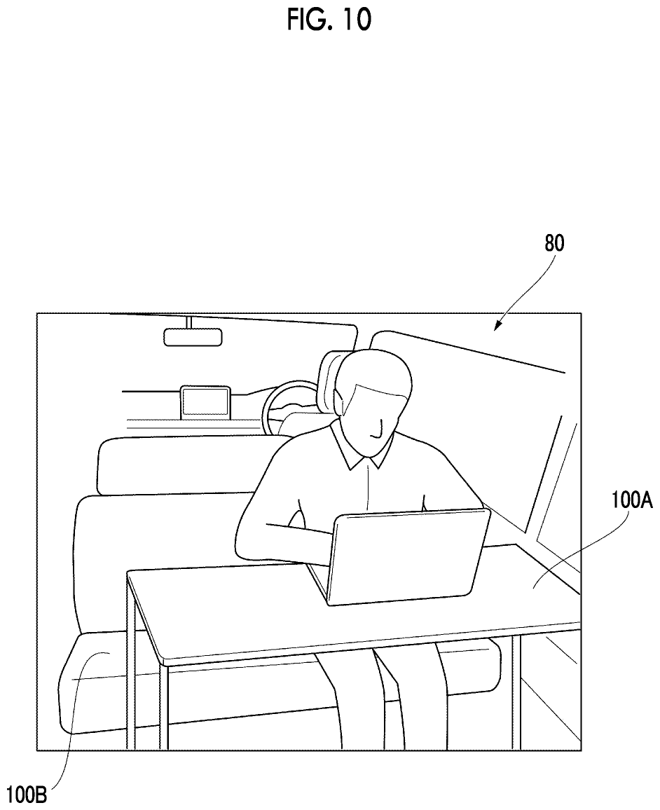

Specifically, in a case where the purpose of use is a meeting-type conference, the CPU 111 selects the car 80 that can be boarded by a large number of persons and is provided with a chair 100B on which persons sit and a table 100A as shown in FIG. 10 (a diagram showing an example of the inside of the selected car 80).

In other words, in a case where a purpose of use specified by the information regarding the purpose of use entered by the user is a conference, the CPU 111 selects the car 80 provided with facilities for the conference.

In a case where the purpose of use is a WEB conference, the CPU 111 selects the car 80 provided with the communication device 803 (refer to FIG. 2) capable of communicating with an external device.

More specifically, in a case where a purpose of use specified by the information regarding the purpose of use entered by the user is a conference between a user inside the car 80 and a person outside the car 80, the CPU 111 selects the car 80 provided with the communication device 803 capable of communicating with the external device.

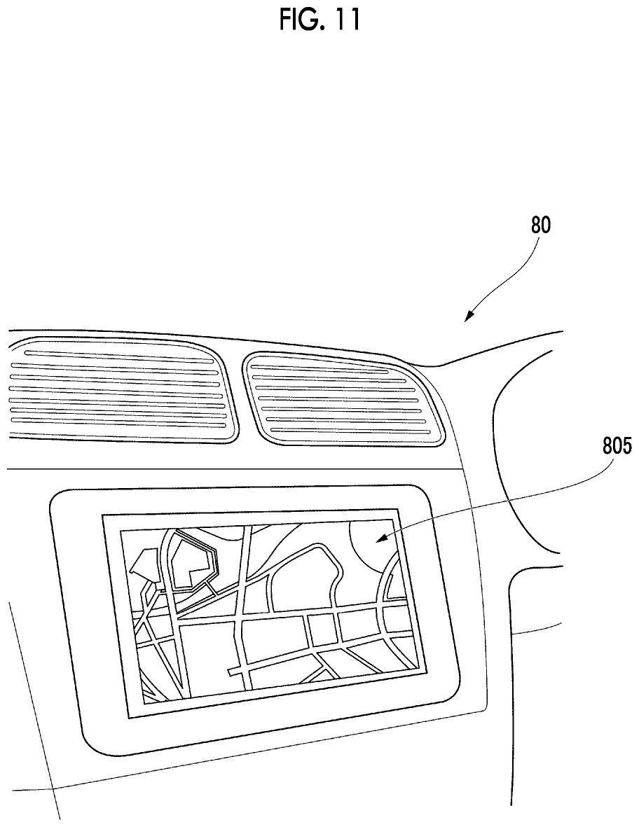

In a case where a purpose of use specified by the information regarding the purpose of use entered by the user is a conference between a user inside the car 80 and a person outside the car 80, the CPU 111 may select the car 80 provided with a display device 805 displaying information as shown in FIG. 11 (a diagram showing another example of the selected car 80).

For example, the CPU 111 may select the car 80 provided with the display device 805 having a size exceeding a predefined size.

As shown in FIG. 11, the car 80 may be provided with the display device 805 that displays various types of information to the user.

In a case where a purpose of use specified by the information regarding the purpose of use entered by the user is a conference between a user inside the car 80 and a person outside the car 80, the CPU 111 selects the car 80 provided with the display device 805 displaying videos.

Consequently, the user can perform a conference using videos with a person outside the car 80 via the display device 805.

In this case, as described above, in a case where the size of the display device 805 exceeds a predefined size and a display region of videos is large, the conference can be performed more smoothly.

For example, in a case where a purpose of use is a conference between the user and a person outside the car 80, the CPU 111 may select the car 80 provided with the display device 805 and the imaging device 816 (refer to FIG. 2) that projects the inside of the car 80.

In this case, the video of the user inside the car 80 can be provided to a person outside the car 80.

In a case where a purpose of use specified by the information regarding the purpose of use entered by the user is, for example, eating or office work, the CPU 111 selects the car 80 provided with the table 100A and the chair 100B as shown in FIG. 10.

In a case where a purpose of use specified by the information regarding the purpose of use entered by the user is, for example, sleeping, the CPU 111 selects the car 80 provided with a chair having a reclining function.

In the display examples shown in FIGS. 9A and 9B, the case where two pieces of information such as the number of persons and a purpose of use are entered in addition to the date and time of use and a use place of use has been described, but only one of the pieces of information may be entered and the car 80 may be selected based on one of the pieces of information such as the date and time of use and the use place.

Other Display Examples

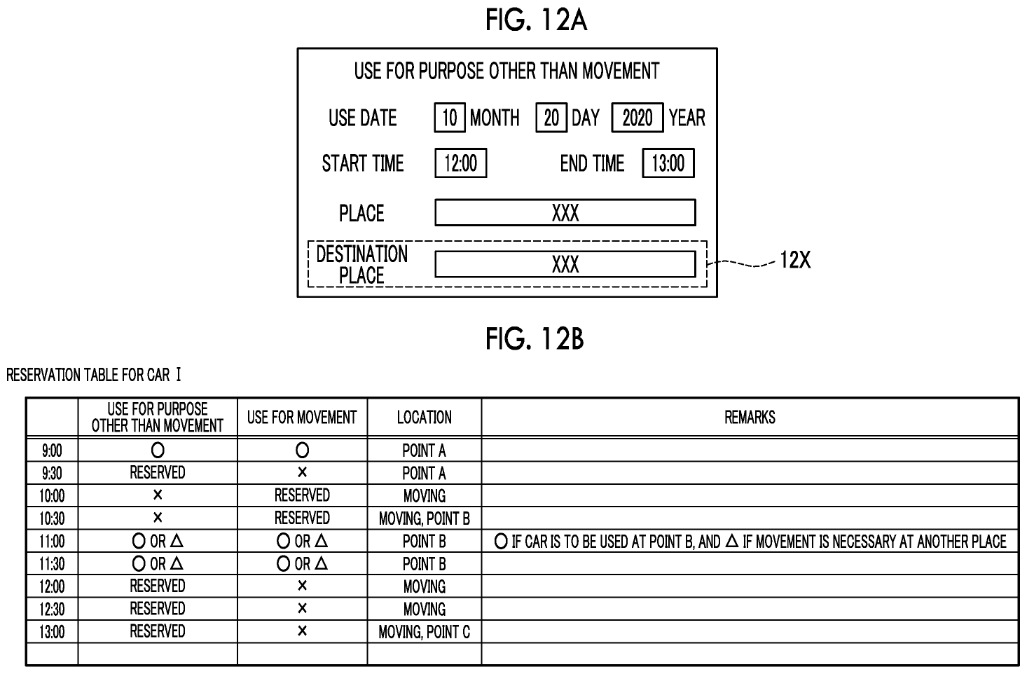

FIGS. 12A and 12B are diagrams showing other display examples on the user terminal 4.

A display screen shown in FIG. 12A is provided with an entry field 12X for entering not only the date and time of use and a use place but also a destination place of the car 80.

This display screen shown in FIG. 12A is a display screen displayed in a case where the user reserves the car 80 for a purpose other than movement, but the entry field 12X for entering a destination place of the car 80 is also displayed on the display screen.

In a case of the car 80 capable of performing automated driving, the user may move to a place different from an initial place while using the car 80 for a purpose other than movement.

In a case where this process is performed, as described above, the entry field 12X for entering information regarding the destination place of the car 80 is also displayed on the user terminal 4, and the user is asked to enter the information regarding the destination place.

FIG. 12B is a diagram showing a reservation table after the user has reserved the car 80 capable of performing automated driving.

This example exemplifies a case where a user who desires to move while using the car 80 for a purpose other than the movement reserves the car 80 during “12:00 to 13:30”.

More specifically, this example exemplifies a reservation in a case where the user rents the car 80 at the point B at “12:00” and moves to the point C while using this car 80 as a workspace.

In a case where this process is performed, the CPU 111 sets the car 80 to be moved while the user is using the car 80 for the purpose of use that can be achieved even though the car 80 is not moved.

More specifically, in a case where a predefined condition is satisfied, such as case where information is entered to the entry field 12X, the CPU 111 sets the car 80 to be moved while the user is using the car 80 for the purpose of use that can be achieved even though the car 80 is not moved.

The CPU 111 transmits information regarding the set details to the car 80. Consequently, at the time reserved by the user, the car 80 heads for the designated destination place while the user is using the car 80 as a workspace or the like.

Others

The CPU 111 may change a fee charged to a user according to a facility of the car 80 used by the user in a case where the user uses the car 80 for a purpose other than movement.

Specifically, the car 80 is provided with a plurality of facilities such as a table, the communication device 803, and the air conditioner 809, and the CPU 111 may change a fee charged to this user according to a facility selected and used by the user from among the plurality of facilities.

Specifically, in a case where the car 80 is used for a purpose other than movement, the user uses the table 100A (refer to FIG. 10), the communication device 803, or the air conditioner 809.

The CPU 111 may determine a fee to be charged to the user according to these facilities used by the user.

Also in a case where the car 80 is used for the purpose of movement instead of a purpose other than movement, a fee to be charged to this user may be similarly determined according to a facility used by the user.

In a case where the user uses the car 80 for the purpose of movement, the user may be requested to present a driver's license.

Specifically, in this case, in a case where the user uses the car 80 for the purpose of movement, the CPU 111 performs a process of requesting the user to present a driver's license.

More specifically, in this case, first, the CPU 111 provides, to the user, a notification for requesting the user to present the driver's license via the user terminal 4.

More specifically, for example, the user is requested to capture images of the driver's license and the face thereof by using a camera function of the user terminal 4. The CPU 111 acquires the image of the driver's license and the image of the user's face.

More specifically, in this case, for example, in a case where the user reserves the car 80 or in a case where the user creates an account necessary for the processing of the present exemplary embodiment, the driver's license and the user's face are imaged. The image of the driver's license and the image of the user's face are sent to the space management server 5.

The CPU 111 or an operator checks the images, and determines whether the user has a driver's license. In a case where the driver has a driver's license, the user can use the car 80 for the purpose of movement.

In a case where the user uses the car 80 for a purpose other than movement, a driver's license is not necessary, and, in this case, the user need not be requested to present the driver's license.

In a case where the user uses the car 80 for the purpose of movement, the user may be requested to provide information regarding an insurance that the user has subscribed.

More specifically, in this case, for example, an image of an insurance card is captured by using the camera function of the user terminal 4, and the image of the insurance card is sent to the space management server 5.

In addition, for example, information regarding a subscribed insurance may be entered via the user terminal 4, and the entered information may be sent to the space management server 5.

The CPU 111 or the operator discounts a usage fee in a case where the user uses the car 80 in a case where a predefined condition such as a large guarantee covered by an insurance is satisfied.

The CPU 111 may decide whether or not to make a reservation of the user according to the position information of the user who reserves the car 80.

Specifically, for example, the CPU 111 may decide whether or not to make a reservation of the user based on position information of the user who reserves the car 80, the shortest required time from a position specified by the position information to a location (use place) of the car 80, and an elapsed time from the current time to the end time of a reservation for the car 80.

More specifically, in this case, in a case where the shortest required time is longer than the elapsed time, the CPU 111 determines that the user cannot reach the car 80 within the reserved time, and does not allow the user's reservation.

In other words, in this case, the CPU 111 determines that the user cannot come to the location of the car 80 by a use end time point of a use time for which the user wants to use the car 80, and does not permit the user to reserve the car 80.

In addition, in a case where the car 80 has already been reserved and the shortest required time is longer than the elapsed time, the reservation may be canceled.

In other words, in a case where the user cannot reach the location of the car 80 by the use end time point (reservation end time point) of the use time for which the user wants to use the car 80, the user's reservation for the car 80 may be cancelled.

In a case where the reservation is canceled as described above, the car 80 can be reserved by another user, and the car 80 can be used more effectively.

Regarding the above-described position information of the user, the CPU 111 acquires the position information of the user by obtaining the position information obtained by the GPS sensor 206 (refer to FIG. 4) provided in the user terminal 4.

Regarding the above-described shortest required time, the CPU 111 accesses, for example, an external site that provides information regarding traffic information to ascertain the shortest required time.

On the other hand, in a case where the shortest required time is shorter than the elapsed time, the user can reach the location of the car 80 by the use end time point, and thus the CPU 111 allows the user's reservation or keeps the user's reservation without canceling the reservation.

In a case where the user uses the car 80 for the purpose of movement, a fee may be changed according to a return place of the car 80.

Specifically, the CPU 111 charges an originally planned fee in a case where the user returns the car 80 at an originally planned place (a place entered in the “destination place” field the part (B) in FIG. 6).

On the other hand, in a case where the user returns the car 80 at a place different from the originally planned place, such as a case where the user makes a mistake in a stop place of the car 80, the CPU 111 performs a process of changing a fee, such as increasing the fee.

In a case where the car 80 is returned at a place different from the originally planned place, the CPU 111 may determine a fee according to a distance between the return place and the originally planned return place.

Specifically, in this case, the CPU 111 performs a determination to increase a usage fee in a case where the distance between the return place and the originally planned return place is larger than a predefined threshold value compared with a case where the distance is not larger than the threshold value.

In a case where the user uses the car 80 for the purpose of movement, information regarding a destination place of the car 80 may be displayed on the display device 805 (refer to FIG. 2) installed in the car 80 or the user terminal 4.

More specifically, for example, navigation information for guiding the user to the destination place of the car 80 may be displayed on the display device 805 installed in the car 80 or the user terminal 4.

Consequently, a situation in which the car 80 is returned at a place different from an originally planned place is less likely to occur.

A reservation person (hereinafter referred to as an “applicant for use”) who uses the car 80 for a purpose of movement or for a purpose other than movement from now on may ascertain a status of the car 80 in a reservation immediately before a reservation of the reservation person.

Specifically, for example, position information of the car 80 used for movement in the reservation immediately before the reservation of the applicant for use may be displayed on the user terminal 4 of the applicant for use who uses the car 80 from now on.

More specifically, in this case, the CPU 111 notifies the applicant for use who uses the car 80 next (the next reservation person of the car 80) of the position information of the car 80 used for movement.

Consequently, the applicant for use who uses car 80 from now on can ascertain a status (position) of the car 80 to be used from now on. In other words, the applicant for use can ascertain a usage status of a user (hereinafter, referred to as a “preceding user”) who is using the car 80 in the previous reservation.

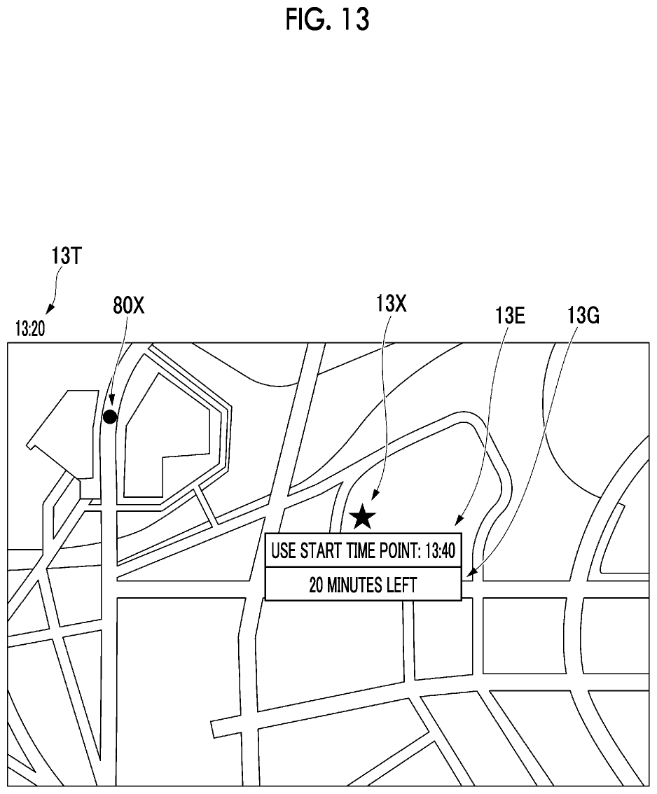

FIG. 13 is a diagram showing a display screen displayed on the user terminal 4 of an applicant for use, and a display screen showing a usage status of a preceding user.

A use place 13X of the applicant for use is displayed on the display screen. The preceding user moves a car to the use place 13X and returns the car.

Position information of the car 80X used by the preceding user is also displayed on the screen. In other words, a usage status for the car 80X by the preceding user is displayed.

The current time 13T is displayed on the display screen. On the display screen, as indicated by the reference sign 13E, a use start time point of the car 80 of the applicant for use is displayed.

On the display screen, as indicated by the reference sign 13G, a remaining time until the use start time point of the car 80 of the applicant for use is displayed. In other words, information regarding a remaining time between the current time and the use start time point is displayed on the display screen.

The applicant for use refers to the display screen, and can thus ascertain the current position of the car used by the preceding user.

As described above, the remaining time until the use start time point is displayed on the display screen.

The applicant for use refers to this screen, and can thus ascertain whether or not the car used by the preceding user will reach a use place by the use start time point of the reservation thereof.

The applicant for use need not ascertain the position information of the car 80 used by the preceding user in a case where a predefined specific process such as paying an additional fee is performed.

More specifically, in a case where a predefined specific process such as paying an additional fee is performed by the preceding user, the position information of the car 80 used by the preceding user need not be displayed on the user terminal 4 of the applicant for use.

In a case where the position information of the car 80 used by the preceding user cannot be basically ascertained and the applicant for use performs a specific process such as paying an additional fee, the position information may be ascertained.

More specifically, in a case where t the position information of the car 80 used by the preceding user cannot be basically ascertained and the applicant for use performs a specific process such as paying an additional fee, the position information may be displayed on the user terminal 4 of the applicant for use.

In a case where a user uses the car 80 for a purpose of movement, a predefined notification may be provided to the user immediately before a reservation time for the car 80 ends.

Specifically, for example, a notification such as “please replenish fuel such as gasoline” or “please charge” may be provided to the user via the display device 805 installed in the car 80, the user terminal 4, or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
acquire information regarding a purpose of use in a case where a user uses a moving object, the information being information regarding a purpose of use that is capable of being achieved even though the moving object is not moved.

2. The information processing system according to claim 1, wherein the processor is configured to:
in a case where the information regarding the purpose of use that is capable of being achieved even though the moving object is not moved is acquired, set the moving object to a setting correlated with the purpose of use.

3. The information processing system according to claim 2,
wherein the setting correlated with the purpose of use that is capable of being achieved even though the moving object is not moved is different from a setting correlated with a purpose of use that is capable of being achieved by moving the moving object.

4. The information processing system according to claim 3,
wherein the number of portions of the moving object that are operable by the user is smaller in the setting correlated with the purpose of use that is capable of being achieved even though the moving object than in the setting correlated with the purpose of use that is capable of being achieved by moving the moving object.

5. The information processing system according to claim 1, wherein the processor is configured to:
in a case where the information regarding the purpose of use that is capable of being achieved even though the moving object is not moved is acquired, set the moving object to a setting that the user is not capable of moving the moving object.

6. The information processing system according to claim 1,
wherein the processor is configured to, in a case where the information regarding the purpose of use that is capable of being achieved even though the moving object is not moved is acquired, perform a process of securing a place for stopping the moving object.

7. The information processing system according to claim 1, wherein the processor is configured to:
select the moving object to be used by the user based on the information regarding the purpose of use that is capable of being achieved even though the moving object is not moved.

8. The information processing system according to claim 7,
wherein the processor is configured to, in a case where a purpose of use specified by the information regarding the purpose of use that is capable of being achieved even though the moving object is a conference performed in the moving object, select the moving object provided with a facility for the conference.

9. The information processing system according to claim 7,
wherein the processor is configured to, in a case where a purpose of use specified by the information regarding the purpose of use that is capable of being achieved even though the moving object is a conference between a user in the moving object and a person outside the moving object, select the moving object provided with a communication device used for communication between the moving object and an external device.

10. The information processing system according to claim 7,
wherein the processor is configured to, in a case where a purpose of use specified by the information regarding the purpose of use that is capable of being achieved even though the moving object is a conference between a user in the moving object and a person outside the moving object, select the moving object provided with a display device that displays videos.

11. The information processing system according to claim 10, wherein the processor is configured to:
select the moving object provided with the display device having a size exceeding a predefined size.

12. The information processing system according to claim 1,
wherein the processor is configured to, in a case where the information regarding the purpose of use that is capable of being achieved even though the moving object is not moved is acquired, select the moving object to be used by users based on the number of the users using the moving object.

13. The information processing system according to claim 1,
wherein the processor is configured to, in a case where a predefined condition is satisfied, move the moving object while the user is using the moving object for the purpose of use that is capable of being achieved even though the moving object is not moved.

14. The information processing system according to claim 1,
wherein the moving object is provided with a plurality of facilities, and
wherein the processor is configured to:
change a fee charged to the user according to a facility used by the user in a case where the user uses the moving object for the purpose of use that is capable of being achieved even though the moving object is not moved.

15. The information processing system according to claim 1,
wherein the processor is configured to, in a case where a purpose of use when the user uses the moving object is movement to another place, request the user to present a driver's license.

16. The information processing system according to claim 1,
wherein the moving object is capable of being reserved, and
wherein the processor is configured to, in a case where the user cannot reach the moving object by a use end time point of a use time desired to be used by the user, cancel a reservation for the moving object by the user or not permit the reservation.

17. The information processing system according to claim 1,
wherein the moving object is capable of being reserved, and
wherein the processor is configured to:
notify a reservation person of the moving object who is going to use the moving object next of position information of the moving object in a case where the moving object is used for movement.

18. A non-transitory computer readable medium storing a program causing a computer to realize:
a function of acquiring information regarding a purpose of use in a case where a user uses a moving object, the information being information regarding a purpose of use that is capable of being achieved even though the moving object is not moved.

19. An information processing method comprising:
acquiring information regarding a purpose of use in a case where a user uses a moving object, the information being information regarding a purpose of use that is capable of being achieved even though the moving object is not moved.
